(19) United States
(12) Patent Application Publication
(10) Pub. No.: US 2008/0288357 A1
(43) Pub. Date: Nov. 20, 2008

(54) RESTAURANT PATRON LOCATION TRACKING AND TABLE TURN MONITORING SYSTEM

(75) Inventors: Robert W. Stambaugh, St. Petersburg Beach, FL (US); Thomas Boyer, St. Petersburg Beach, FL (US)

Correspondence Address: DENNIS G. LAPOINTE;LAPOINTE LAW GROUP, PL, PO BOX 1294, TARPON SPRINGS, FL, 34688-1294, US

(73) Assignee: RESTAURANT TECHNOLOGY CONCEPTS, INC., St. Pete Beach, FL (US)

(21) Appl. No.: 11/839,054

(22) Filed: Aug. 15, 2007

Related U.S. Application Data
(63) Continuation-in-part of application No. 11/749,329, filed on May 16, 2007.

(51) Int. Cl. G06Q 50/00; G01S 1/00

(52) U.S. Cl. 705/15; 340/539.13

(57) ABSTRACT

A restaurant facility patron location tracking system that includes a restaurant networked table management system and portable pucks that have an ID chip reader which associates with a table with a ID chip located at the table, thereby allowing for the real-time monitoring and updating of location of customers within the facility. The system is programmed to associate the customer location to the food order number and allows users to query the system to determine the location of a patron by food order number or to query the system to determine the food order number by location. The networked system is a networked control, communication and display system with one or more monitoring stations and wireless communication with portable pagers and the pucks.

### RELATED APPLICATION

This application is a continuation-in-part of application Ser. No. 11/749,329 filed May 16, 2007.

### FIELD OF THE INVENTION

This application related to fast casual restaurant operations, in particular, to a method and system of locating patron at tables after they have ordered and then seated themselves.

### BACKGROUND OF THE INVENTION

In restaurants, known as “fast casual” restaurants, there exists an opportunity to improve service and efficiency concerning to the process where the customer is required to wait or be recalled to a food service station until their food order is ready, can be improved. This same process where the patron is responsible for transporting food-laden tray(s) to their table is service methodology that is not customer friendly and a liability. The Location Patron Tracking system, also referred to herein as Locus Patron Tracking system, will identify the location of a patron so their order can be delivered by service staff expediently.

### SUMMARY OF THE INVENTION

The Locus patron tracking system operationally includes;

monitoring and updating location of customers;

associating the customer location to the food order number;

a function that allows users to query the system to determine the location of a patron by food order number; and

a function that allows users to query the system to determine the food order number by location.

When a customer opts to wait for their food order at a location other than a table, the system will not be able to resolve the table location of their order. When an unresolved order is queried, a message indicating the location is unknown will display.

The Table Turn Patron Tracking (Locus) product is an add-on module to the Table Turn Table Management System disclosed in U.S. Pat. No. 6,980,088 issued Dec. 27, 2005 to Starabaugh, which is incorporated by reference herein in its entirety. It is also an add-on to a similar table turn management system described in U.S. patent application Ser. No. 11/749,329 filed May 16, 2007, which is also incorporated by reference herein in its entirety. The invention is comprised of a network of Table Turn table management monitors, portable pager units and portable locating modules (“pucks”). The number of fixed Table Turn panels, pager units and puck modules is determined by the application and can be deployed in any number or combination.

### Function:

When a customer places an order he/she is given a Locus portable location or locating module to take to their chosen table. Their customer order number is associated with a unique ID number. ID numbers are printed on the puck graphics and are also assigned and programmed into the electronics contained inside.

Each dining table is equipped with a passive or active RFID (radio frequency identity) “chip”. The ID chip placed into/onto the tables identify the table number (as defined by each individual establishment).

The Locus modules contain a RFID reader. When a module is placed on a table (equipped with the RFID chip) the reader within the module identifies its associated table.

The restaurant service staff may query the system by submitting a query customer location by order number or a query order number by table. An alternate method of locating portable locating modules within a facility is to use a Local Positioning System.

### Background Information on RFID:

Radio-frequency identification (RFID) is an automatic identification method, relying on storing and remotely retrieving data using devices called RFID tags or transponders. An RFID tag is an object that can be stuck on or incorporated into a product, animal, or person for the purpose of identification using radiowaves. Some tags can be read from several meters away and beyond the line of sight of the reader.

Most RFID tags contain at least two parts. One is an integrated circuit for storing and processing information, modulating and demodulating a (RF) signal and perhaps other specialized functions. The second is an antenna for receiving and transmitting the signal. A technology called chipless RFID allows for discrete identification of tags without all integrated circuit, thereby allowing tags to be printed directly onto assets at lower cost than traditional tags.

### Background on Local Positioning System (LPS);

Local Positioning is similar technology to global positioning systems except the area covered is limited to the radio range of the system's antenna array. Usually the array is limited to a building, warehouse, construction site, automobile or equipment lot. The position resolution on a local system can be much better compared to GPS systems with resolution errors within 6 inches.

Table Turn Functions for the LOCUS system:

Table Turn Stations: Will illuminate the table locations that contain a portable location unit. A staff member can query the panel's occupied table locations to determine associated order number (puck ID) or query the order, panel indicates table location.

Signal Caller Pagers; Can query the occupied table locations to determine associated order number (puck ID) or can query the order, panel indicates table location.

### Features:

The Locus modules are rechargeable portable devices approximately the size of a cellular phone. They are stored on a charging stand and the battery is user replaceable.

### System Setup and Optional Features:

A system option can be incorporated such that the Locus modules have an orientation sensor that will sense and report which side of the module or “puck” is facing up. A label is placed on each side of the puck, one indicating to the patron to place “this side up” when dining, the other indicating “this side up” when leaving the table. When the module is flipped to indicate “leaving,” the system sends a text message to the dining area busser that the table needs to be cleared and/or cleaned for the next party. The text message will indicate which table requires service by table number.

When the order location is unknown, the user will have the option of paging the customer. The puck will vibrate and flash indicating to the patron their order is ready and can be retrieved.

RFID chips can also be place in trash receptacles to sense when a puck has been discarded. A message will be sent to the staff directing them to retrieve the unit. The retrieval message can also include the specific trash container that holds the discarded puck. RFID chips can be placed in exit doorways to alter the staff that a portable position unit has exited the working area. The facility staff can then recover the departing unit.

### Module Setup Options:

The Locus modules have no modifiable user options and are preferably water resistant,

### BRIEF DESCRIPTION OF THE DRAWINGS

In the accompanying drawings,

FIG. 1 is a conceptual schematic representation of a system network and the communication between pagers in a restaurant status information networked system and the locating modules/tables of the present invention, and

FIG. 2 is a block diagram depicting the active components (enclosure and hardware not shown) in the locating module and how they relate to each other.

### DETAILED DESCRIPTION OF THE INVENTION

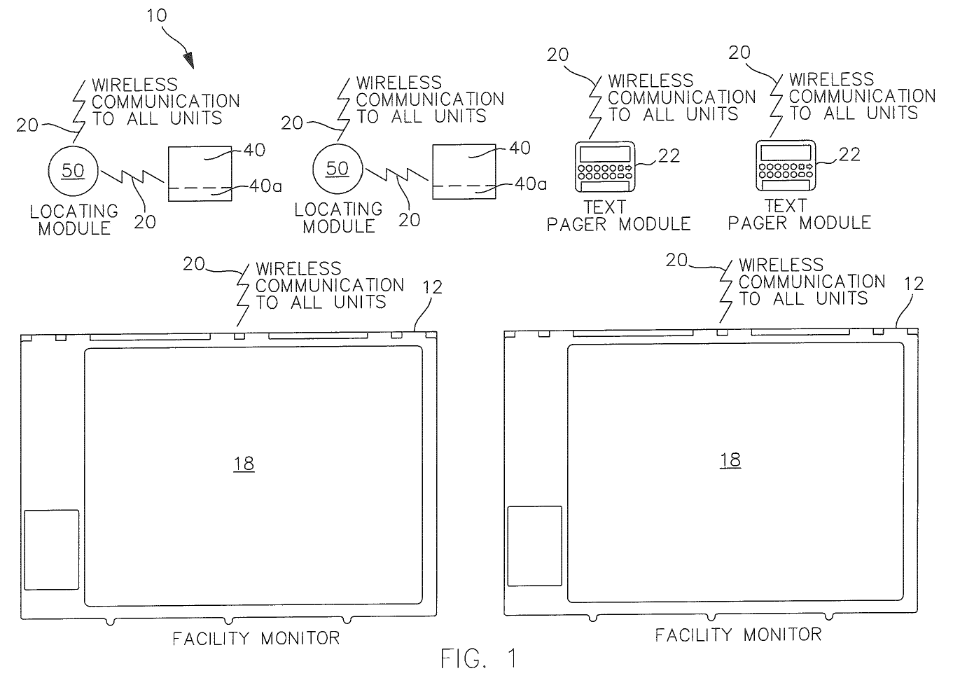

Referring to FIG. 1, the invention includes an add-on comprising a patron location tracking system combined with a facility status information networked control, communication and display system 10 that includes one or more monitoring stations 12. Each station 12 is configured and adapted to display a facility layout.

Each station 12 has indicia (not shown), which are representative of specific designated areas of the facility available for use. The indicia further serves as means for communicating to a staff member a status or a need in a designated area of said facility.

It is preferable that the station 12 have a touch screen 18 for activating desired status changes on the system, as well as the ability to illuminate the selected indicia as described herein above and in U.S. Pat. No. 6,980,088 to Stambaugh. As described in that patent, the system 10 is programmed to provide status changes and communicating such status changes simultaneously to each station 12, which is electrically and operatively connected to the stations 12 or is in wireless electronic communication with the stations 12. An example of circuitry that would operate the system 12 is found in FIGS. 9A-9B of U.S. Pat. No. 6,980,088 to Stambaugh, which represent an electrical schematic of one example of how to assemble the circuitry to operate a system using a basic touch screen, LED technology and a restaurant overlay.

One preferred embodiment however is that each station be able to communicate with each other or between a table 40 and a location module or puck 50 by wireless electronic communication transmissions 20 as well as to communicate similarly between a plurality of portable pagers 22 and the stations 12. Portable pagers 22 are optional devices to be incorporated in the invention claimed herein.

The stations 12 and the portable pagers 22 each having means for sending and receiving updated status changes corresponding to specific designated areas, sending page requests to other users within the system 10, and sending text messages to other users within the system 10. The portable pucks 50 are similarly equipped with means for sending and receiving signals so that a patron can be located and associated with a specific table 40 or other location within the facility or that the puck 50 itself can be located if not at a table, such as when a customer tosses the puck in the trash or attempts to leave the premises with the puck or module.

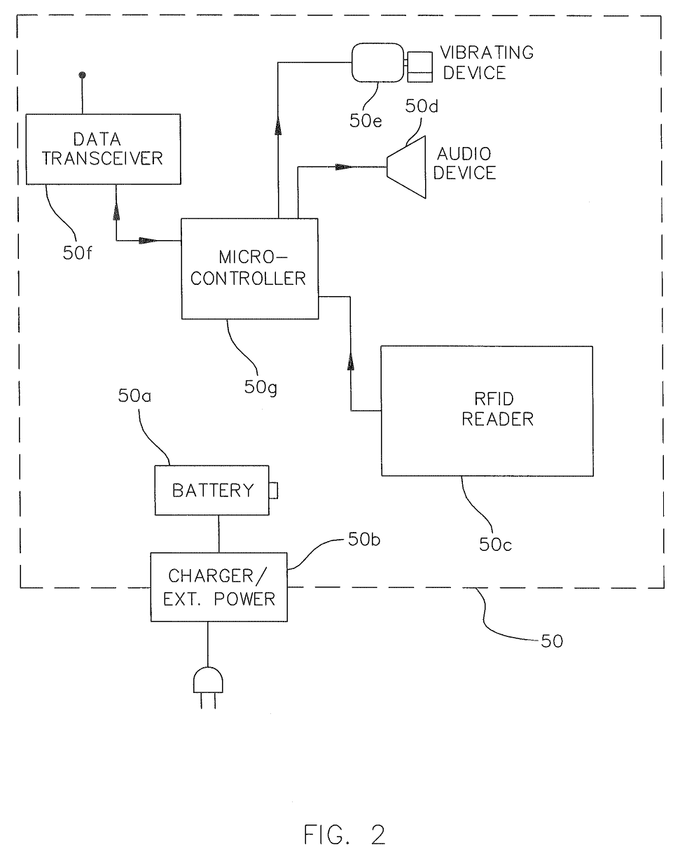

FIG. 2 is a block diagram depicting the active components (enclosure and hardware not shown) in the location module 40 and how they relate to each other. It is preferred that the battery 50a be capable of being recharged is external power through a charger 50b. An RFID Reader 50c is also incorporated in the module 50, which is capable of reading the ID chip 40a located in or at table 40. The chip 40a can also be located elsewhere within or outside the facility such as at the lobby, counter service area, trash cans, entry way, outside the entry way, etc. It is being shown in the drawing located at the table as the most common useful purpose. Other optional components are an audio device 50d and a vibrating device 50e to be integrated with the module 50. The transceiver 50f and micro-processor 50g are also depicted in the drawing.

The invention is therefore a restaurant facility patron location tracking system 10 comprising a facility status information networked control, communication and display system having one or more monitoring stations 12, each station 12 comprising means 18 for displaying a facility layout; and programmable circuitry means for operating and controlling the system 10, including providing information changes.

Typical information changes includes information related to food order number and patron location within the restaurant facility.

The invention includes means for communicating such information changes simultaneously to the stations 12 electrically and operatively connected to the stations 12 or in wireless electronic communication thereto as conceptually designated by numeral 20, with said stations 12. The programmable circuit means further comprising wireless electronic communication means 20 for communicating between the stations 12 and one or more portable patron location modules 50. The modules 50 have a radio frequency identification chip reader 50a, which includes means for reading an ID Chip 40a located at a desired location 40 such as a table, trash can, lobby area, entry way, service counter, outside the premises, wherein the location 40 of the portable patron location module 50 is communicated to a restaurant staff person when queried. This function allows for the real-time monitoring and updating of location of customers within the restaurant facility.

The system includes means for associating a patron location 40 to a food order number. That is, the system includes means for determining a location of the patron by food order number or to determine the food order number by location.

The modules 50 include means such as an orientation sensor that will sense and report which side of the module 50 or “puck” is facing up.

The location modules 50 may optionally include means for locating the modules 50 using a local positioning system installed within predetermined areas or key areas or locations 40 of the facility. These locations 40 are defined by the area in space where they exist and communication with the local positioning signal is made. The portable patron location module 50 would report to the system its location by key area 40 when the module 50 enters the space defined as that key area 40.

It should be understood that the preceding is merely a detailed description of one or more embodiments of this invention and that numerous changes to the disclosed embodiments can be made in accordance with the disclosure herein without departing from the spirit and scope of the invention. The preceding description, therefore, is not meant to limit the scope of the invention. Rather, the scope of the invention is to be determined only by the appended claims and their equivalents.

What is claimed is:

1. A restaurant facility patron location tracking system comprising:
a facility status information networked control, communication and display system having one or more monitoring stations, each station comprising means for displaying a facility layout;
programmable circuitry means for operating and controlling the system, including providing information changes and communicating such information changes simultaneously to said stations electrically and operatively connected to said stations or in wireless electronic communication with said stations, said programmable circuit means further comprising wireless electronic communication means for communicating between said stations and one or more portable patron location modules; and
said one or more portable patron location modules having a radio frequency identification chip reader, including means for reading an ID Chip located at a desired location, wherein said location of said portable patron location module is communicated to a restaurant staff person when queried, and wherein said communication allows for the real-time monitoring and updating of location of customers within the restaurant facility.

2. The system according to claim 1, wherein the system includes means for associating a patron location to a food order number.

3. The system according to claim 2, wherein the system includes means for determining a location of said patron by food order number and to determine the food order number by location.

4. The system according to claim 2, wherein said information changes includes information related to food order number and patron location within said restaurant facility.

5. The system according to claim 1, wherein said location modules further comprise means for sensing and reporting which side of said module is facing up.

6. The system according to claim 1, wherein said location modules further comprise means for locating and reporting said location of said modules using a local positioning system installed within predetermined areas of said facility.
